(19) United States
(12) Patent Application Publication
(10) Pub. No.: US 2012/0052478 A1
(43) Pub. Date: Mar. 1, 2012

(54) FLIP FLASHCARDS

(76) Inventor: James Paul REID, Toronto (CA)

(21) Appl. No.: 13/216,632

(22) Filed: Aug. 24, 2011

(30) Foreign Application Priority Data
Aug. 24, 2010 (CA) 2713252

(51) Int. Cl. B43L 1/02

(52) U.S. Cl. 434/413; 434/416

(57) ABSTRACT

A pack or set of four-sided, waterproof flashcards, which facilitates alternating between several subjects such as spelling, math and pattern recognition. One of the two faces of each flashcard is labelled with specific pairings of alpha-numeric characters or specific mathematical symbol pairings, or is substantially blank. Labelled in one of the four corners of the alternate faces of all of the flashcards in the set is a single small shape (for example, an oval shape). The colour of this shape varies, depending upon the information which is labelled on the aforementioned reverse faces of the flashcards. All of the flashcards may display non-permanent information, which can be printed, written or drawn by users onto both faces of the flashcards, with wet or dry erase markers, for many different interrelated learning purposes.

### TECHNICAL FIELD

The present disclosure relates to the field of educational flashcards.

### BACKGROUND

Educational flashcards intended to improve children's knowledge of spelling, math and many other subject areas have existed for a long time. These flashcards are typically designed to teach children single subject areas. For example, flashcards intended to teach children mathematics may come in the form of a set of flashcards that display different mathematical statements like “1+1=(blank)”. Other sets of flashcards may display letters, words or pictures of different objects, in order to teach children spelling or picture recognition skills. Many teachers therefore purchase multiple sets of flashcards to teach their students different subject areas. The subject matter scope, ease of use, and financial cost of these flashcard sets are therefore far from optimal. Furthermore, flashcards are typically constructed out of paper or cardboard stock of varying strengths, which tend to break down and fray at the edges over time. Worn out flashcards are costly and a nuisance to replace, and serve as unappealing learning devices for children to look at and handle in the classroom. Another drawback of existing flashcards are the limited ways in which they encourage their users to write, print, or draw various pieces of information onto their faces (when such an option exists at all). For example, a mathematical flashcard displaying the statement “1+1=(blank)” clearly calls on the user to perfunctorily print the number “2” on the flashcard face. No other number could reasonably be applied to such a flashcard. Creative thinking, which could result from flashcards which encouraged multiple-answer responses, is therefore not encouraged. There is therefore a need for a new and improved set of cost-effective, durable flashcards that stand up over time to extended use and enable teachers to teach multiple subject areas in heretofore unattainably efficient, versatile and creative ways.

### BRIEF DESCRIPTION OF THE DRAWINGS

In drawings which illustrate by way of example only an embodiment of the invention,

FIG. 1 is an illustration of a flashcard with slightly rounded corners;

FIG. 2 is an illustration of a flashcard with concave vertical sides;

FIG. 3 is an illustration of a first face of a flashcard with an alpha-numeric pairing;

FIG. 4 is an illustration of a first face of another flashcard with a mathematical symbol pairing;

FIG. 5 is an illustration of a first face of yet another flashcard with non-permanent writing thereon;

FIG. 6 is an illustration of a first face of a blank flashcard;

FIG. 7 is an illustration of a second face of a flashcard;

FIG. 8 is an illustration of an arrangement of first faces of three flashcards which demonstrates a cooperative function of the flashcards to represent the fraction “one-sixth”;

FIG. 9 is an illustration of a first face of a blank flashcard used in conjunction with the arrangement of flashcards of FIG. 8, with non-permanent “⅙” written thereon;

FIG. 10 is an illustration of a first face of a blank flashcard used in conjunction with the arrangement of flashcards of FIG. 8, with non-permanent “one-sixth” written thereon;

FIG. 11 is an illustration of an arrangement of first faces of four flashcards which demonstrates the cooperative function of the flashcards to represent the word “maps”;

FIG. 12 is an illustration of second faces of the four flashcards of FIG. 11;

FIG. 13 is an illustration of the second faces of the four flashcards of FIG. 12 wherein the relative positions of the flashcards are rearranged; and,

FIG. 14 is an illustration of an arrangement of second faces of three flashcards which demonstrates the cooperative function of the flashcards to represent a pattern and a first face of a fourth flashcard representing the recognized pattern.

### DETAILED DESCRIPTION

To overcome some of the disadvantages of conventional educational flashcards, a pack or set of four-sided flashcards constructed out of a waterproof material (for example, a plastic, plastic-like, or laminated material or coating), which enables teachers to easily alternate back and forth between improving children's spelling, math and pattern recognition skills, in addition to many other subjects, is provided. Labelled on one of the two faces—the first face—of the majority of the flashcards are specific pairings of alpha-numeric characters (along with indicia, such as a logo and/or name). Labelled on the first face of a minority of the flashcards are specific mathematical symbol pairings (along with indicia, such as a logo and/or name). Labelled on the first face of a further minority of the flashcards is nothing—they are blank (except for indicia, such as a logo and/or name). Labelled in one of the four corners of the alternate faces—the second faces—of all of the flashcards in the flashcard set is a single small shape (for example, an oval shape). The colour of this shape varies, depending upon the information which is labelled on the aforementioned reverse faces of the flashcards. All of the flashcards have the capacity to display non-permanent information, which can be printed, written or drawn by users onto both faces of the flashcards, with wet or dry erase markers, for many different interrelated learning purposes.

In one embodiment there is provided a set of educational flashcards, comprising a number of flashcards that are labelled on one of their two faces with specific alpha-numeric character pairings (along with indicia, such as a logo and/or name), a number of flashcards that are labelled on one of their two faces with specific mathematical symbol pairings (along with indicia, such as a logo and/or name), and a number of flashcards that are blank on one of their two faces (except for indicia, such as a logo and/or name). All aforementioned flashcards are completely blank on their alternate faces, except for a small coloured shape (for example, an oval shape), which is labelled on one of the four corners of the said flashcard faces. All aforementioned flashcards are constructed out of a durable material, which allows users to print, write or draw temporary information onto both faces of the flashcards (with writing instruments like dry or wet erase markers) which can subsequently be removed and/or wiped away.

In further aspects of this embodiment, the flashcards are primarily rectangular in nature, with the two vertical sides of the flashcards not running exactly perpendicular to the two parallel horizontal sides, the two vertical sides tapering slightly inward toward the flashcard's center region in a concave fashion, both vertical sides tapering in toward the center region of the flashcard in an identical manner, such that if a vertical line of symmetry was drawn through the center of the flashcard, the tapered vertical sides would be mirror images of each other and four corners of the flashcard are slightly rounded; the flashcards are constructed out of a waterproof material (for example, a plastic, plastic-like, or laminated material or coating), which protects the integrity and construction of the flashcards from wearing out or deteriorating, when they are exposed to liquid (for example, water) which may be used to wipe away information that has been applied to the flashcard by users with various writing instruments; the dimensions of each flashcard are approximately eight centimetres by twelve centimetres (subsequent iterations of the invention may feature flashcard sizes that differ from these dimensions, either larger or smaller, for novelty and/or practical purposes); one of the two faces of all of the flashcards in the flashcard set are free of any labelled alpha-numeric characters, mathematical symbols, or information of any kind, except for a shape (for instance, an oval shape) which is labelled in one corner of the said flashcard faces, the said shape being coloured one of four different colours: green, yellow, blue or black, and the rest of the said flashcard face is blank, which affords users as much surface area as possible to print, write, draw, or otherwise apply information onto the said flashcard face, with various writing instruments; one of the two faces of a majority of the flashcards is labelled with specific alpha-numeric character pairings, and one of the two faces of a minority of the flashcards is labelled with specific mathematical symbol pairings, wherein both said pairing types are labelled in specific locations on said flashcard face; the specific alpha-numeric character pairings consist of one letter character labelled right-side up in the upper left-hand corner of said flashcard face, one upside-down number character labelled in the lower right-hand corner of said flashcard face, and indicia such as a logo and/or name are labelled in the center region of said flashcard face; the alpha-numeric character pairings and positional logic therein described is labelled on said flashcards, such that if the flashcards are rotated 180 degrees in the user's hands, the said number character will be right-side up in the upper left-hand corner of the said flashcard face, and the said letter character will be upside-down, in the lower right-hand corner of the said flashcard face; each alpha-numeric character labelled flashcard in the flashcard set is labelled with a different and distinct said alpha-numeric character pairing; one flashcard in the flashcard set is labelled with the alpha character “a” and numeric character “1”, another flashcard in the set is labelled with the alpha character “b” and numeric character “2”, etc. such that the twenty-four other alpha-numeric character labelled flashcards in the set are labelled c 3, d 4, e 5, f 6, g 7, h 8, i 9, j 0, k 1, l 2, m 3, n 4, o 5, p 6, q 7, r 8, s 9, t 0, u 1, v 2, w 3, x 4, y 5, z 6 following the aforementioned alpha-numeric character pairing logic; said alpha-numeric characters' individual font size widths do not exceed one-third of the overall width of the flashcard faces upon which they are labelled (e.g., if the flashcard width is eight centimetres, for example, neither the alpha character nor the numeric character labelled on the flashcard can exceed 2.66 centimetres in width), however blank space may exist on the flashcards beside the alpha-numeric characters, so that the users may print, write, draw or otherwise apply additional information on to said blank space; the mathematical symbol pairings consist of one mathematical symbol labelled in the upper left-hand corner of said flashcard face, another mathematical symbol labelled in the lower right-hand corner of said flashcard face, and indicia (logo and/or name) labelled in the center region of the said flashcard face; each mathematical symbol labelled flashcard in the flashcard set is labelled with a different and distinct said mathematical symbol pairing; one flashcard in the flashcard set is labelled with the mathematical decimal symbol (“.”) in one corner, and with the mathematical fraction symbol (“/”) in the diagonally opposite corner and following this aforementioned mathematical symbol pairing layout logic, the two other mathematically labelled flashcards in the set are labelled as follows: one flashcard is labelled with a multiplication symbol (“×”) in one corner and a division symbol (“÷”) in the diagonally opposite corner, and another flashcard is labelled with the mathematical plus symbol (“+”) in one corner and the mathematical minus symbol (“−”) in the diagonally opposite corner; said mathematical symbols' individual font size widths do not exceed one-third of the overall width of the flashcard faces upon which they are labelled (e.g., if the flashcard width is eight centimetres, for example, the mathematical symbols which are labelled on the flashcard cannot exceed 2.66 centimetres in width), however blank space may exist on the flashcards beside the mathematical symbols, so that the users may print, write, draw or otherwise apply additional information on the said blank space; one face of at least three of the said flashcards in the flashcard set is substantially blank (except for indicia such as a logo and/or name, which is labelled in the center region of the said flashcard face), providing users with a lot of room on said flashcard face to print, write, draw or otherwise apply information, which will enhance the overall learning utility and experience of the said flashcard set; the coloured shapes that appear on one of the two faces of all of the flashcards in the flashcard set are specifically linked, according to their colour, with the alpha-numeric character, mathematical symbol, and blank flashcard information that is labelled on the reverse faces of the said flashcards, the specific linking system working as follows: the “a 1” flashcard has a green shape labelled on its reverse face, the “b 2” flashcard has a yellow shape labelled on its reverse face, the “c 3” flashcard has a blue shape labelled on its reverse face, and according to this logic, the rest of the alpha-numeric flashcards are as follows, with the colour of the shape that is labelled on the reverse face of each flashcard listed in brackets: d 4 (green shape), e 5 (yellow shape), f 6 (blue shape), g 7 (green shape), h 8 (yellow shape), i 9 (blue shape), j 0 (green shape), k 1 (yellow shape), l 2 (blue shape), m 3 (green shape), n 4 (yellow shape), o 5 (blue shape), p 6 (green shape), q 7 (yellow shape), r 8 (blue shape), s 9 (green shape), t 0 (yellow shape), u 1 (blue shape), v 2 (green shape), w 3 (yellow shape), x 4 (blue shape), y 5 (green shape), z 6 (yellow shape), and the mathematical symbol flashcards are as follows, with the colour of the shape that is labelled on the reverse face of each flashcard listed in brackets: decimal fraction (green shape), multiply divide (yellow shape), plus minus (blue shape), and wherein the blank flashcards all have black shapes labelled on their reverse faces; the set of flashcards consists of a layout design logic that allows users to order the said flashcards from left to right, such that the succession of alpha characters labelled on the flashcards can work in unison to spell out words, with or without users printing or writing additional alpha characters onto alpha character labelled flashcards, or onto blank flashcards, which may be included in the sequentially ordered flashcard arrangement; the set of flashcards consists of a layout design logic that allows users to order the said flashcards from left to right, such that the succession of numeric characters and mathematical symbols labelled on the flashcards can work in unison to display mathematical values, or mathematical statements, with or without users printing or writing additional numbers and/or mathematical symbols onto numeric character or mathematical symbol labelled flashcards, or onto blank flashcards, which may be included in the sequentially ordered flashcard arrangement; the set of flashcards consists of a layout design logic that allows users to order the said flashcards from left to right, such that the succession of coloured shapes labelled on the flashcards can work in unison to display precise patterning logic arrangements, with or without users drawing additional coloured shapes onto coloured shape flashcards, or onto blank flashcards, which may be included in the sequentially ordered flashcard arrangement; and/or the set of flashcards consists of a complementary, flexible design that enables the alpha-numeric character flashcards, mathematical symbol flashcards, blank flashcards, and their corresponding coloured shape reverse flashcard faces to work together cooperatively (along with the flashcards' capacity to display user-applied information), which enables users to fluidly switch back and forth between improving their spelling skills and knowledge, their mathematical skills and knowledge, and their patterning skills and knowledge.

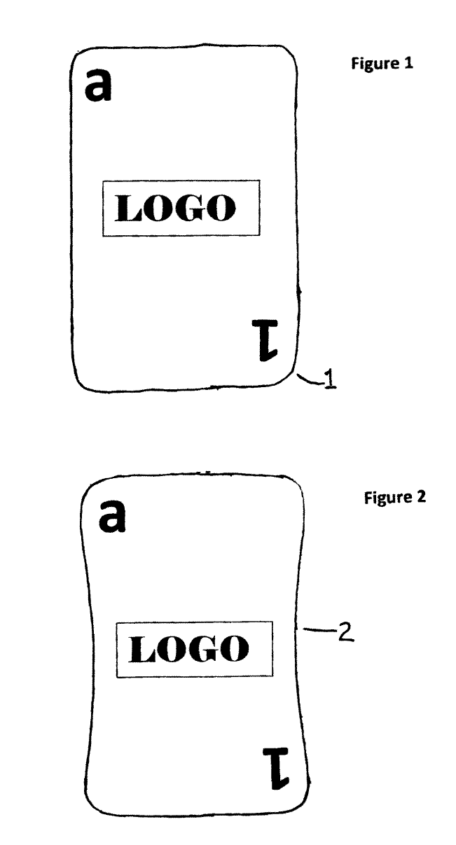

Referring to FIG. 1, the flashcards may be rectangular in shape, with slightly rounded corners 1. Alternatively, referring to FIG. 2, the flashcards may closely approximate a rectangular shape—but not exactly—according to the following design: the vertical sides of the flashcards would not run exactly perpendicular to the horizontal sides; rather, they would taper slightly inward, toward the flashcard's center region 2, in concave fashion. The horizontal sides would be straight (i.e. run parallel to each other) and the four corners of the flashcards would be rounded slightly. This design is meant to give the flashcards a pleasing visual appearance. It is also meant to give the flashcards a pleasing tactile “feel” when held. Both features will hopefully contribute to the flashcards' overall appeal to teachers and students.

In an exemplary embodiment, the four-sided flashcards are approximately eight centimetres by twelve centimetres in size. In other embodiments, the size of the flashcards may differ from these dimensions, either larger or smaller, for novelty and/or practical purposes.

The flashcards come in a set, which is comprised of at least thirty-three flashcards. One face of the flashcards is permanently labelled as follows:

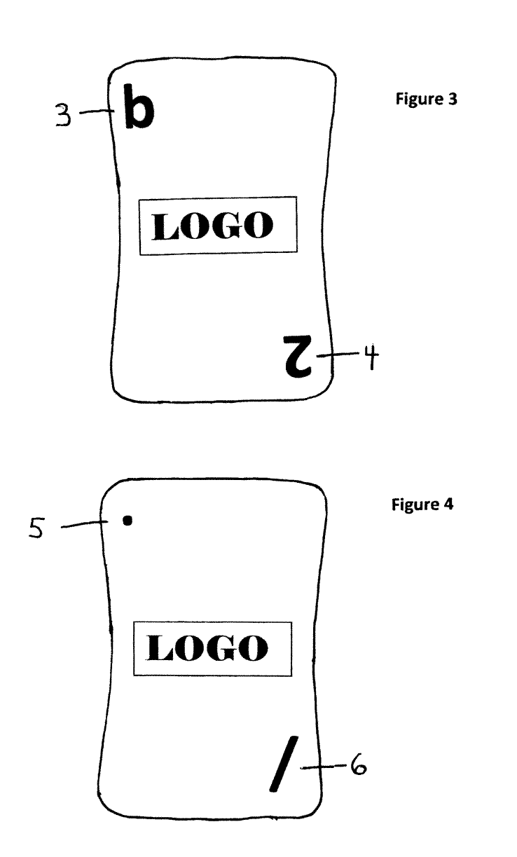

The first flashcard is labelled with a right-side up, letter “a” on its upper left-hand corner, and an upside-down number “1” on its bottom right-hand corner. Therefore, when the flashcard holder rotates the flashcard 180 degrees in his/her hands, the number “1” presents right-side up in the flashcard's upper left-hand corner, and the letter “a” presents upside-down on the flashcard's lower right-hand corner. According to this same positional logic, referring to FIG. 3, the second flashcard in the deck is labelled with a letter “b” in one corner 3 of the flashcard, and with the number “2” in the opposite diagonal corner 4. The letter/number pairings for the subsequent twenty four flashcards in the deck (which follow the same positional logic described above) are as follows: c 3, d 4, e 5, f 6, g 7, h 8, i 9, j 0, k 1, l 2, m 3, n 4, o 5, p 6, q 7, r 8, s 9, t 0, u 1, v 2, 3, x 4, y 5, z 6.

The same face of the additional flashcards in the pack is labelled as follows:

Following the positional logic as described above, referring to FIG. 4, one flashcard is labelled with a mathematical decimal symbol (“.”) in one corner 5, and a mathematical fraction symbol (“/”) in its opposite diagonal corner 6.

Another flashcard is labelled with a mathematical multiplication symbol (“×”) in one corner, and a mathematical division symbol (“÷”) in its opposite diagonal corner.

Another flashcard is labelled with a mathematical plus symbol (“+”) in one corner, and a mathematical minus symbol (“−”) in its opposite diagonal corner.

The same face of the aforementioned flashcards is labelled with indicia, such as a logo and name, in their center region.

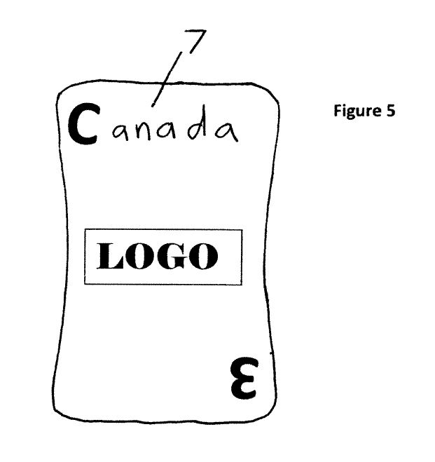

All of the aforementioned flashcards, due to the precise placement of the numbers, letters and mathematical symbols that are labelled on them, have blank space next to (i.e. beside) the said numbers, letters, and mathematical symbols, which extends to the edge of the flashcards. This blank space can be printed, written, or drawn upon by users with writing instruments (like wet or dry erase markers). The information that users choose to apply to these blank space areas, may in many cases share a word-meaning or number-sense relationship with the said numbers, letters, and mathematical symbols which it is applied next to. For example, referring to FIG. 5, a student may be given the “c” flashcard, and be asked to complete the spelling of “Canada” across the aforementioned blank area 7 of the said flashcard. The student would have the opportunity, thanks to the layout and logic of the flashcard design, to print or write the letters “a”, “n”, “a”, “d”, “a” immediately beside and to the right of the “c”, to complete the task. The said blank space sections of the flashcards therefore provide very important function, flexibility, and learning opportunities to users.

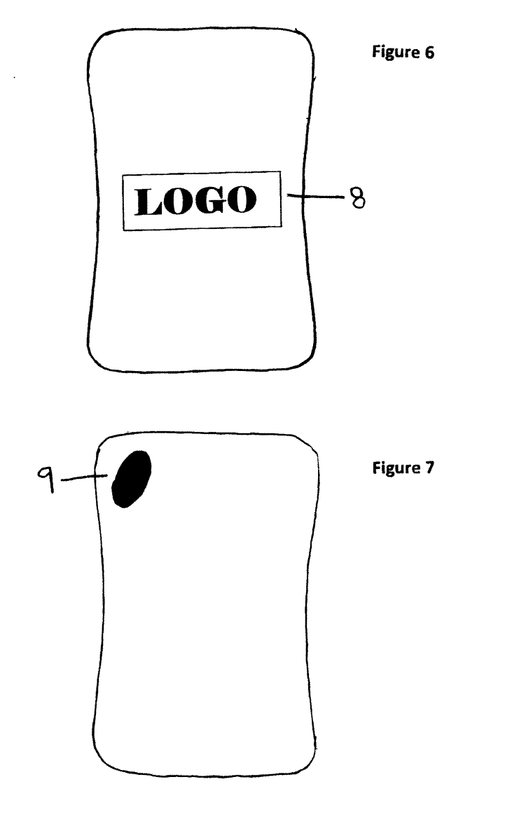

Referring to FIG. 6, the same face of at least three additional flashcards is substantially blank, labelled with nothing other than indicia, such as a logo and/or name, in their center region 8. These flashcards will be referred to henceforth as “blank flashcards” and they serve many useful purposes—which will be described more fully below.

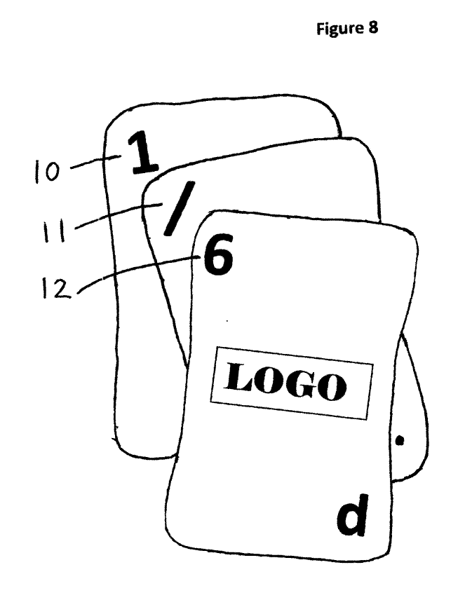

Referring to FIG. 7, the opposite face of all the aforementioned flashcards are blank, except for a relatively small shape (for instance, an oval) which is labelled in a single corner 9 of each said flashcard face. The shape can either be green, yellow, blue, or black. The shape colour depends on the precise way in which the alternate faces of the said flashcards are labelled. Following is a list of the flashcards in the set, and the corresponding shape colour, in brackets, that is assigned to each said flashcard's alternate face: a 1 (green shape), b 2 (yellow shape), c 3 (blue shape), d 4 (green shape), e 5 (yellow shape), f 6 (blue shape), g 7 (green shape), h 8 (yellow shape), i 9 (blue shape), j 0 (green shape), k 1 (yellow shape), l 2 (blue shape), m 3 (green shape), n 4 (yellow shape), o 5 (blue shape), p 6 (green shape), q 7 (yellow shape), r 8 (blue shape), s 9 (green shape), t 0 (yellow shape), u 1 (blue shape), v 2 (green shape), w 3 (yellow shape), x 4 (blue shape), y 5 (green shape), z 6 (yellow shape), decimal fraction (green shape), multiply divide (yellow shape), plus minus (blue shape). The aforementioned “blank flashcards” are all labelled with black shapes.

The term “labelled” as used herein does not mean that any characters, symbols or shapes are “attached” or “affixed” in any way to the flashcards. Rather, the term “labelled” is meant to be synonymous with the phrase “permanently printed with”.

As mentioned above in the description of this embodiment, all of the flashcards are constructed out of a plastic, plastic-like, or laminated material or coating. This construction enables users to print, write or draw on both sides of the flashcards with dry or wet-erase markers, and then later wipe away what they have applied, with dry or wet tissue papers, cloths, or the like. The ability of users to apply temporary information on both sides of the alpha-numeric, mathematical symbol and blank flashcards allows for a wide range of teaching strategies for teachers and learning opportunities for students.

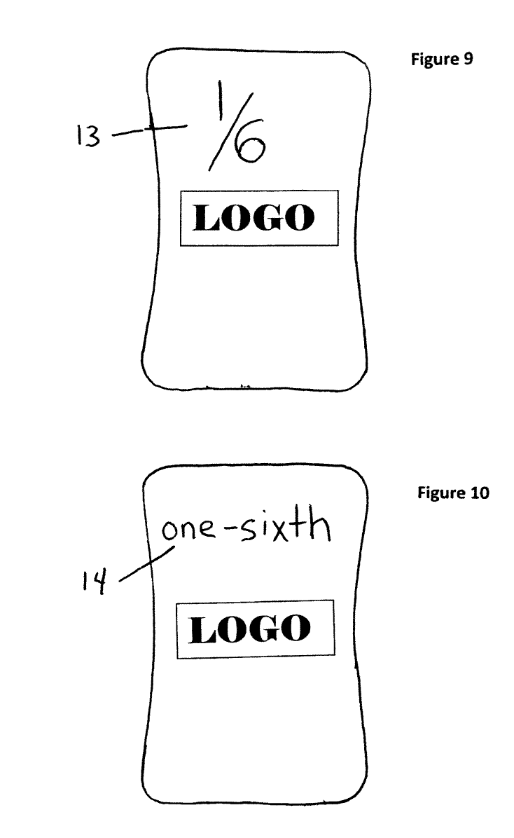

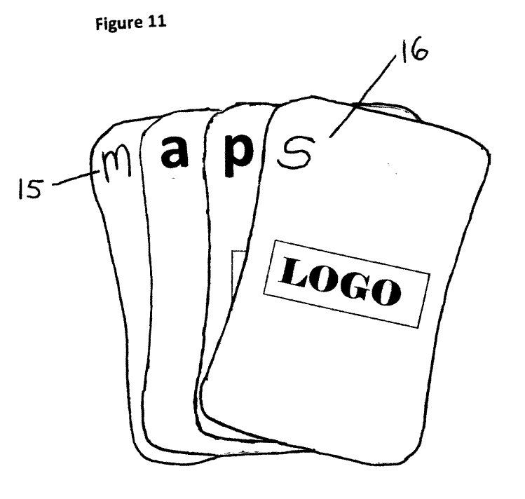

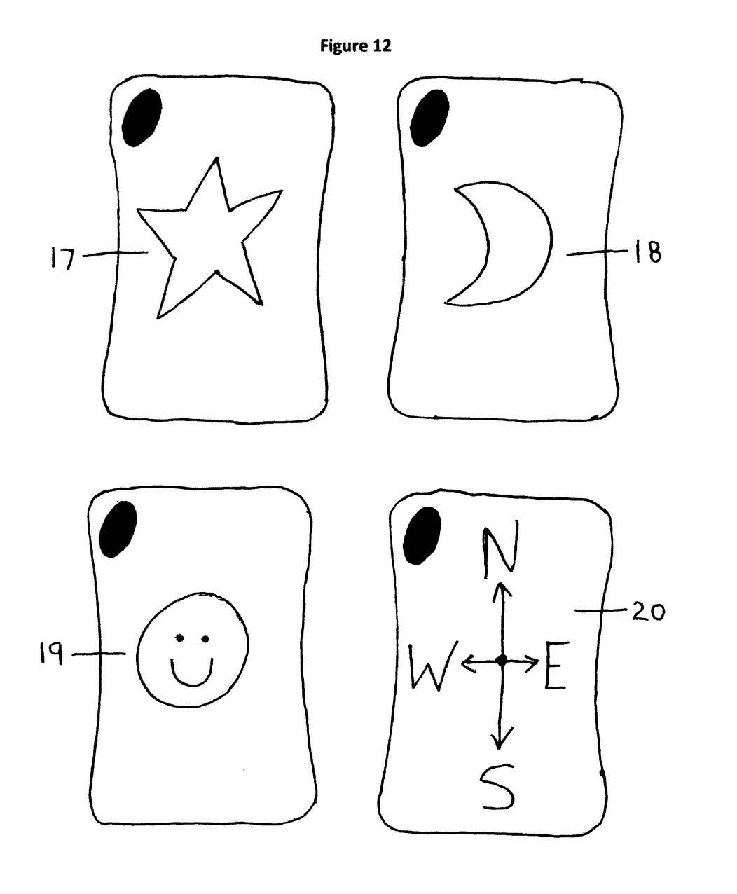

The flashcards' specific alpha numeric character pairings, and alternate-face coloured shapes, are intentionally positioned on the flashcards in a way which enables them to function together cooperatively in many different ways. This cooperative relationship allows teachers to nimbly alternate back and forth between different subject areas which they are teaching. For example, referring to FIG. 8, a student could be asked to arrange several flashcards sequentially on her or his desk, to represent “one-sixth”. The correct arrangement would therefore begin with a “1” flashcard 10, overtop of which and slightly below and to the right, would sit the “/” flashcard 11, overtop of which and slightly below and to the right, would sit a “6” flashcard 12. Referring to FIG. 9, the student could then be asked to print “⅙” on a blank flashcard 13, for reinforcement purposes. Referring to FIG. 10, this reinforcement could be strengthened further, by asking the student to print out “one-sixth” in English on a second blank flashcard 14. The three flashcard arrangement could then be rotated 180 degrees, and the “/” flashcard discarded. The two blank flashcards could then be erased, and one could be inserted into the two-flashcard arrangement, such that the blank flashcard is first in the order, overtop of which and slightly to the right would sit the “a” flashcard, overtop of which and slightly to the right would sit the “p” flashcard. Referring to FIG. 11, the student could then be asked to print the appropriate letter (“m”) on the blank flashcard 15, which is required to have the flashcards collectively spell out the word “map”. A second blank flashcard 16 could then be placed overtop of and slightly to the right of the “p” flashcard, and the student could then be asked to pluralize the existing word “map” by printing the appropriate letter (“s”) on the second blank flashcard 16.

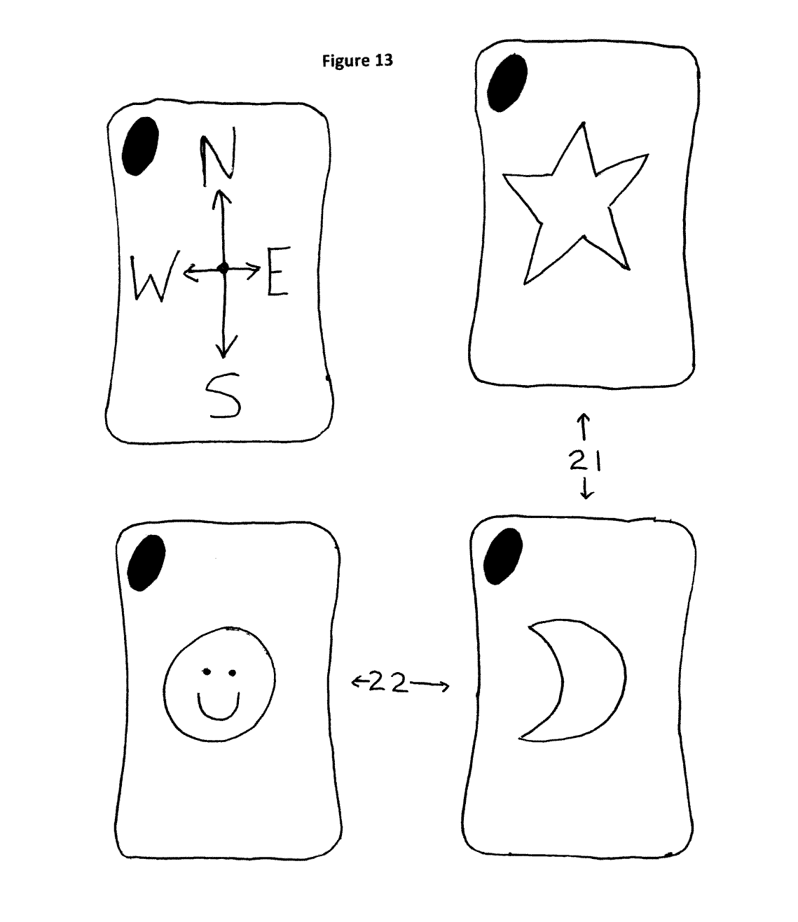

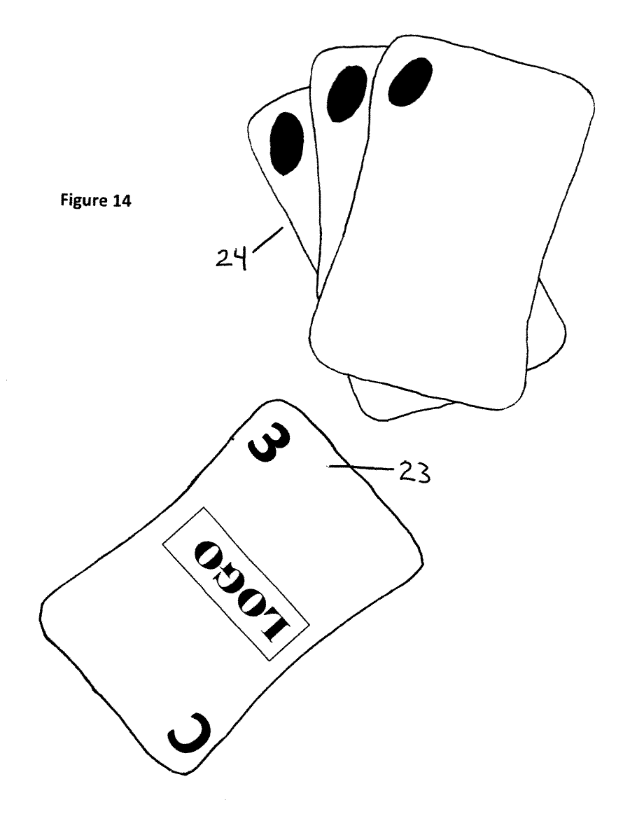

Enabling teachers to alternate fluidly back and forth between teaching spelling and number sense skills in the manner outlined above provides for a lively, entertaining, rich learning experience for students. Additional subject areas can also be integrated into the learning process. For instance, in the scenario described above, after the student spells out the word “maps”, the teacher could flip the four flashcards over. This could reveal the fact that the teacher has drawn a picture of a different object on each of the four flashcards. Referring to FIG. 12, one flashcard 17 could depict a star, another flashcard 18 could depict a moon, another flashcard 19 could depict a happy face, and the last flashcard 20 could depict a rudimentary compass. The student could then be reminded that on maps, north/south/east/west directional logic is important. Referring to FIG. 13, the teacher could then ask the student to refer to the compass picture flashcard, and position the three other picture flashcards, such that the star flashcard is north 21 of the moon flashcard, which is east 22 of the happy face flashcard. Once the student has accomplished this task, the student could be asked to draw images or words on additional flashcards in the set, which relate to geography. Or, the labelled flashcard letters could be referred to, and the student could be asked to carry out a task like spelling out the word “north”, on the “n” flashcard.

The coloured shapes on the alternate faces of the flashcards can be integrated into many learning activities as well. For instance, the teacher could ask a young student to pick up one of the flashcards that has a “3” character labelled on its face, and place it beside one of two arrangements of flashcards that sit in front of the student (one arrangement could be comprised of three flashcards ordered together, which display three shapes sitting in a row, and the other arrangement could be comprised of four flashcards ordered together, which display four shapes sitting in a row). Referring to FIG. 14, the student could then be asked to place the “3” flashcard 23 next to the arrangement 24 that the student believes displays three shapes sitting in a row. The shapes could also be used to teach students how patterning logic works. For instance, an “a/b/a” pattern can be established by placing a green shape flashcard next to a yellow shape flashcard, next to a green shape flashcard. More challenging patterns like aa/bb/cc/dd could also be taught and established with the flashcards, as the student's patterning skills improve. Students could also work together in pairs or groups, taking turns designing and duplicating each other's shape patterns.

It is clear that many teaching/learning scenarios, involving diverse subject areas, can be created with this versatile set of flashcards. What must also be emphasized is the fact that these teaching/learning scenarios would not be confined to the classroom; children could learn from and use the flashcards with their parents, siblings, friends, or on their own as well.

Various embodiments having been thus described in detail by way of example, it will be apparent to those skilled in the art that variations and modifications may be made without departing from the invention. The invention includes all such variations and modifications as fall within the scope of the appended claims.

1. An educational card set, comprising:
an erasable writing instrument; and
a plurality of cards each comprising a first face and an opposite face, the first face and the second face comprising a surface adapted to receive and release markings from the erasable writing instrument,
the first face of each of a majority of the plurality of cards being labelled with a corresponding one of a set of character pairings, a first character of said corresponding character pairing being located at a first corner of the first face and a second character of said corresponding character pairing being located at an opposite corner of the first face.

2. The educational card set of claim 1, wherein each character pairing of the set of character pairings comprises an alphabet character and a numeric character.

3. The educational card set of claim 1, wherein each of the majority of the plurality of cards is labelled with a distinct one of the set of character pairings.

4. The educational card set of claim 1, wherein the first face of each of a minority of the plurality of cards is labelled with a corresponding one of a set of symbol pairings, a first symbol of said corresponding symbol pairing being located at a first corner of said first face and a second symbol of said corresponding symbol pairing being located at an opposite corner of said first face, the cards comprised in the minority being cards other than those comprised in the majority.

5. The educational card set of claim 4, wherein the first face of each of said minority of the plurality of cards comprises a blank space extending between said first symbol and another corner of said card, such that said blank space is at least about two-thirds of a width of said card.

6. The educational card set of claim 1, wherein the first face of each of said majority of the plurality of cards comprises a blank space extending between said first character and another corner of said card, such that said blank space is at least about two-thirds of a width of said card.

7. The educational card set of claim 5, wherein the first face of each of said majority of the plurality of cards, minority of the plurality of cards, or both said majority and minority of the plurality of cards, comprises a further blank space extending between said second character or second symbol and a further corner of said card, such that said further blank space is at least about two-thirds of a width of said card.

8. The educational card set of claim 1, wherein each of said plurality of cards is further labelled with a corresponding one of a plurality of distinct shapes on a corner of the opposing face, each one of the plurality of distinct shapes being labelled on more than one of said plurality of cards.

9. The educational card set of claim 1, wherein each of the plurality of cards comprises laminated material.

10. The educational card set of claim 1, wherein each of the plurality of cards comprises a plastic material.

11. The educational card set of claim 1, wherein each of the plurality of cards comprises a plastic coating.

12. An educational flashcard set, comprising:
a plurality of flashcards, each of said flashcards comprising a first face and an opposite face,
a majority of the plurality of flashcards being labelled with a distinct one of a set of character pairings, a first character of said distinct character pairing being located at a first corner of the first face and a second character of said distinct character pairing being located at an opposite corner of the first face,
a first minority of the plurality of flashcards other than said majority being labelled with a distinct one of a set of symbol pairings, a first symbol of said distinct symbol pairing being located at a first corner of the first face and a second symbol of said distinct symbol pairing being located at an opposite corner of the first face,
the first face of each of said majority and first minority of the plurality of flashcards comprising a blank space extending between said first character or first symbol and another corner of said flashcard, such that said blank space is at least about two-thirds of a width of said flashcard,
each of said plurality of flashcards further being labelled with a corresponding one of a plurality of distinct shapes on a corner of the opposing face, each one of the plurality of distinct shapes being labelled on more than one of said plurality of flashcards.

13. The educational flashcard set of claim 12, wherein each character pairing of the set of character pairings comprises an alphabet character and a numeric character.

14. The educational flashcard set of claim 12, wherein a second minority of the plurality of flashcards other than the majority or first minority of the plurality of flashcards is not labelled with either one of the set of character pairings or one of the set of symbol pairings.

15. The educational card set of claim 12, wherein the first face of each of said majority of the plurality of cards, first minority of the plurality of cards, or both said majority and first minority of the plurality of cards, comprises a further blank space extending between said second character or second symbol and a further corner of said card, such that said further blank space is at least about two-thirds of a width of said card.

16. The educational flashcard set of claim 12, wherein each of the plurality of cards comprises laminated material.

17. The educational flashcard set of claim 12, wherein each of the plurality of cards comprises a plastic material.

18. The educational flashcard set of claim 12, wherein each of the plurality of cards comprises a plastic coating.

19. The educational flashcard set of claim 12, wherein at least the first face of each of said flashcards comprises a surface adapted to receive and release markings from an erasable writing instrument.

20. A kit comprising the education flashcard set of claim 19 and the erasable writing instrument.
